(19) United States
(12) Patent Application Publication
(10) Pub. No.: US 2026/0019442 A1
(43) Pub. Date: Jan. 15, 2026

(54) SCALABLE MODULAR UNIFIED COMPUTING INFRASTRUCTURE VULNERABILITY MONITORING

(71) Applicant: Wells Fargo Bank, N.A., San Francisco, CA (US)

(72) Inventors: Joshua D. Beverly, Graham, NC (US); Dhruv B. Bhatt, Indian Trail, NC (US); Rajeev Thylur Puttaswamy, Mandya (IN); Rajesh Velamala, Concord, NC (US)

(21) Appl. No.: 19/062,984

(22) Filed: Feb. 25, 2025

(30) Foreign Application Priority Data
Jul. 9, 2024 (IN) 202411052464

(51) Int. Cl. H04L 9/40

(52) U.S. Cl. CPC H04L 63/1433

(57) ABSTRACT

Systems and techniques for scalable modular unified computing infrastructure vulnerability monitoring are described herein. Data is aggregated from multiple computing system monitoring tools across different computing infrastructure components. The aggregated data is analyzed to determine a health score for each of the computing infrastructure components based on predefined metrics. The health scores are displayed in a user interface alongside real-time performance data of the computing infrastructure components. Potential computing system issues are identified based on deviations in the health scores and performance data from baseline values. Alerts corresponding to the identified issues are generated and recommended corrective actions to be taken are presented in the user interface.

### CLAIM OF PRIORITY

This application claims the benefit of priority to India patent application No. 202411052464, filed on Jul. 9, 2024, which is incorporated herein by reference in its entirety.

### TECHNICAL FIELD

Embodiments described herein generally relate to computing infrastructure performance, health, and vulnerability monitoring and, in some embodiments, more specifically to scalable modular unified infrastructure vulnerability monitoring.

### BACKGROUND

In today's fast-paced and technology-driven world, organizations rely heavily on Information Technology (IT) infrastructure to support their operations and deliver services efficiently. The stability and security of IT systems are paramount, as any disruption can lead to significant operational challenges and financial losses. Organizations employ various IT systems and applications that are critical for their day-to-day operations, making the management of these systems a complex task.

Managing IT infrastructure involves monitoring numerous systems and applications to ensure they are functioning correctly and efficiently. Traditionally, this requires the use of multiple monitoring tools, each designed to handle specific aspects of the IT environment. This can include tools for network monitoring, application performance monitoring, security systems, and more. The use of disparate tools leads to challenges in obtaining a unified view of the health and performance of the entire IT landscape.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a block diagram of an example of an environment and a system for scalable modular unified computing infrastructure vulnerability monitoring, according to an embodiment.

FIG. 2 illustrates a flow diagram of an example of a data flow for scalable modular unified computing infrastructure vulnerability monitoring, according to an embodiment.

FIGS. 3A, 3B, and 3C illustrate an example of an information technology dashboard view for scalable modular unified computing infrastructure vulnerability monitoring, according to an embodiment.

FIGS. 4A and 4B illustrate an example of a business dashboard view for scalable modular unified computing infrastructure vulnerability monitoring, according to an embodiment.

FIGS. 5A and 5B illustrate an example of an architecture for scalable modular unified computing infrastructure vulnerability monitoring, according to an embodiment.

FIG. 6 is a flow diagram of an example of a method for scalable modular unified computing infrastructure vulnerability monitoring, according to an embodiment.

FIG. 7 is a block diagram illustrating an example of a machine upon which one or more embodiments may be implemented.

### DETAILED DESCRIPTION

Change management is a critical process in IT management, involving the implementation of changes to the IT infrastructure in a controlled and efficient manner. Poorly managed changes can lead to system outages and disruptions. Similarly, effective incident management, which involves identifying, analyzing, and correcting hazards to prevent a future re-occurrence, is crucial. These processes need to be managed with precision to avoid additional issues.

Applications are the backbone of many business operations, and their stability and security are crucial for maintaining business continuity. Any downtime or security breach can have immediate adverse effects on an organization's operations and reputation. Therefore, ensuring the continuous availability and security of applications is a significant concern for IT departments.

Proactively identifying potential issues before they cause significant impact is another critical requirement in IT management. This involves continuous monitoring and analysis of the IT infrastructure to detect anomalies that could indicate potential problems. Early detection allows organizations to address issues before they escalate, reducing downtime and the associated costs.

With the increasing complexity of IT environments, integrating and coordinating between different IT management tools and processes has become more challenging. Each tool often operates in isolation, making it difficult to correlate data across different sources and gain a holistic view of the IT health. Computing infrastructure technicians may desire a unified solution that can consolidate information from various monitoring tools and provide a comprehensive view of IT health and performance. Such a solution would enhance the ability to manage the IT infrastructure more effectively, streamline processes, and improve decision-making capabilities.

Computing environments use multiple, disparate monitoring tools for different aspects of IT infrastructure, leading to fragmented views and difficulty in obtaining a comprehensive understanding of system health. Managing IT changes and incidents with separate tools and processes complicates coordination, increases the risk of errors, and can lead to prolonged downtime. The systems and techniques discussed herein integrate disparate monitoring and management processes into a unified platform. This integration enables generation of a consolidated view of IT health and performance metrics across multiple platforms, simplifying monitoring and management tasks. Existing systems may fail to proactively identify issues before they impact the computing environment, relying instead on reactive measures that address problems after they have caused damage to infrastructure operation. The technical solution discussed herein facilitates comprehensive monitoring by aggregating data from various IT infrastructure components, change management processes, and application stability and security assessments. This comprehensive monitoring enables proactive issue identification and swift resolution.

Conventional techniques for integrating and analyzing data from various sources to assess IT health and performance are complex and time-consuming and may rely on manual intervention and expertise. As organizations grow, their IT infrastructure becomes more complex, making it challenging for existing monitoring and management tools to scale effectively. The systems and techniques discussed herein feature a modular design that enables scalability and flexibility to accommodate varying organizational needs and computing environment complexities. This design supports efficient scaling as the organization's IT infrastructure evolves. By leveraging advanced analytics capabilities, real-time data-driven insights and metrics are generated. The real-time data-driven insights empower stakeholders to make informed decisions regarding organizational computing stability and performance, enhancing operational efficiency. Adaptive optimization strategies are supported, enabling organizations to refine their operational processes based on insights gleaned from computing environment monitoring data. This continual enhancement of processes helps maintain computing environment stability and performance even as conditions change. By addressing these technical computing problems with innovative technical solutions, the systems and techniques discussed herein improve IT infrastructure management, making computing infrastructure monitoring more efficient, proactive, and scalable. This approach reduces computing system downtime, operational risks, and efficiency in computing resource (e.g., processor, memory, storage, etc.) efficiency.

The solution discussed herein builds upon a comprehensive understanding of critical components contributing to organizational stability, particularly in contexts heavily reliant on IT Infrastructure. A modular design is used that enables scalability and flexibility to accommodate varying organizational needs and complexities. An integration framework is incorporated that is capable of seamlessly amalgamating diverse monitoring tools and data sources utilized across the computing infrastructure. A sophisticated data aggregation mechanism at the core consolidates information from IT Infrastructure monitoring, change management processes, and application stability and security assessments. A unified dashboard interface is used to enable presentation of a unique technical arrangement of user interface elements that enables stakeholders to use a single point of access to monitor health and performance of critical computing components. The architecture design enables efficient scalability, ensuring optimal performance even as organizational requirements and the computing infrastructure evolve over time.

The systems and techniques discussed herein facilitate comprehensive monitoring of IT Infrastructure stability, change management processes, and applicational stability and security. Through continuous monitoring, proactive identification of potential issues or vulnerabilities can be identified before they escalate into significant disruptions. Advanced analytics capabilities generate data-driven insights and metrics, empowering stakeholders to make informed decisions regarding organizational stability and performance. By offering a consolidated view of organizational health, management efforts are streamlined, reducing the complexity associated with independently managing disparate processes. An intuitive interface and real-time reporting capabilities empower decision makers to respond promptly to emerging challenges and opportunities fostering agility and resilience within the organization. Adaptive optimization strategies are supported, allowing organizations to refine their operational processes based on insights gleaned from monitoring data, there by continually enhancing stability and performance. The architecture embodies modularity, integration and scalability providing functions that enable comprehensive monitoring, proactive issue identification, data-driven insights, streamlined management, enhanced decision-making and adaptive optimization strategies.

Conventional monitoring tools may not provide a consolidated view of IT Monitoring, Change Management & Business Indicators Monitoring or a comprehensive view of infrastructure, application, operational, and business health metrics in a consolidated view to describe the health summary of the IT infrastructure. Conventional monitoring tools may address each area independently, but the stability of a business organization depends on the stability of the infrastructure, application, operational, and business components. A consolidated view enables effective management of the organization. The systems and techniques discussed herein provides a comprehensive view by merging data from Operational, Infrastructure, Change Management, Application and Business performance Indicators.

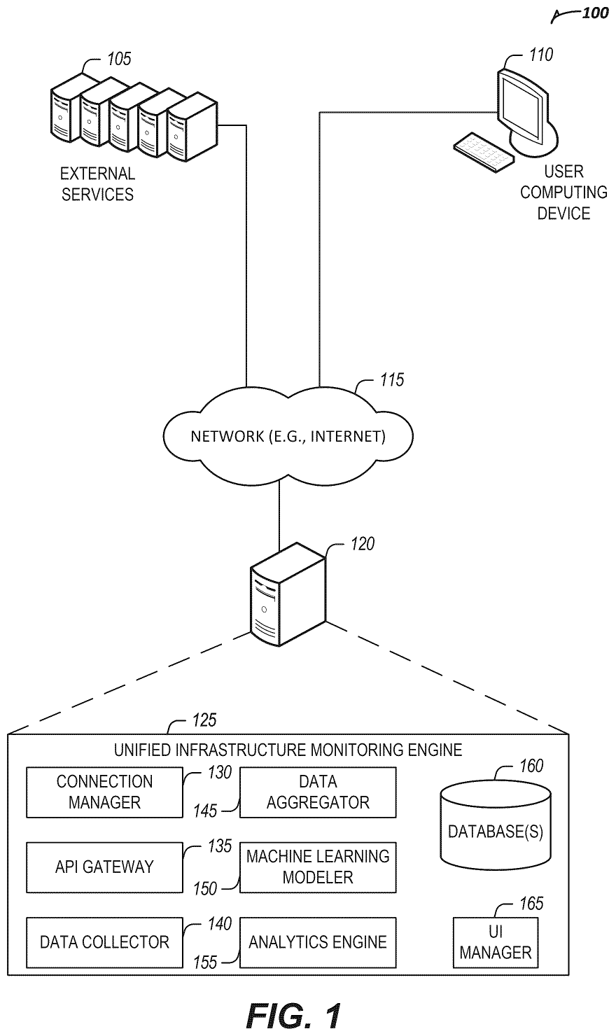

FIG. 1 is a block diagram of an example of an environment 100 and a system 125 for scalable modular unified computing infrastructure vulnerability monitoring, according to an embodiment. The environment 100 includes external services 105 that include internal and external data sources that maintain data regarding elements (e.g., computing devices, applications, etc.) of the IT infrastructure. The environment 100 includes a variety of end user computing devices (e.g., desktop computer, laptop computer, smartphone, tablet computing device, etc.) such a user computing device 110. The external systems 105 and the user computing device 110 are communicatively coupled to a server computing device 120 (e.g., a standalone server, a cluster of servers, a cloud computing platform, a virtualized computing platform, an application specific integrated circuit (ASIC), a field programmable gate array (FPGA), system on chip (SoC), etc.) via a network 115 (e.g., a local area network, wide area network, metropolitan area network, wireless network, cellular network, radio network, the Internet, etc.).

The server computing device 120 includes the system 125. In an example, the system may be a unified infrastructure monitoring engine. The system 125 includes a variety of components such as a connection manager 130, an application programming interface (API) gateway 135, a data collector 140, a data aggregator 145, a machine learning modeler 150, an analytics engine 155, database(s) 160, and a user interface (UI) manager 165. The components of the system 125 may operate on a single server computing device such as server computing device 120 or may be spread across multiple server computing devices in whole or in part.

The connection manager 130 includes logic and a variety of interfaces that connect with external systems 105 to pull or push data. The external systems 105 to which the connection manager 130 may establish connections may include (1) IT monitoring tools such as systems like APPDYNAMICS, BIG PANDA, SPLUNK, etc. that provide data about IT infrastructure health, (2) change management systems such as tools like SERVICENOW that manage IT change requests and incidents, and (3) business performance tools and systems that monitor business-specific key performance indicators (KPIs) and key business indicators (KBIs).

The API Gateway 135 serves as an entry point for client requests from the user computing device 110 and routes the request to appropriate internal or external services 105. 1. Real-time APIs are used to collect data from various observability tools and change management processes. Representational state transfer (REST) calls are used to integrate with multiple monitoring systems including APPDYNAMICS, ELASTIC SEARCH, SPLUNK, and other data sources. Connectors are used by the connection manager 130 that source data from various observability tools and change management processes via real-time APIs by the data collector 140. The data collector 140 fetches data from the external systems 105.

RESTful APIs facilitate aggregation of data from diverse monitoring tools by the data aggregator 145 to provide a comprehensive overview of organizational health. The data aggregator 145 aggregates data from the external systems 105 into a unified format and with appropriate granularity for analysis. REST calls seamlessly amalgamate diverse monitoring tools and data sources utilized across the organization. REST calls are initiated on a periodic (e.g., five minute, etc.) schedule to pull updated information from various systems while avoiding excessive load on source systems. The APIs enable on-demand data refresh capabilities when immediate updates are needed.

RESTful APIs are part of a micro-services architecture that enables communication between different components for service integration. REST is used as part of a technology stack alongside other technologies like PYTHON, ANGULAR, and MONGODB to enable integrated system functionality. The REST calls facilitate exchange of information between front-end dashboard interfaces and back-end services enabling data from multiple sources to be obtained and aggregated while maintaining reference data in the database(s) 160. The database(s) 160 hold a variety of data used by the system 125. For example, an operational database stores real-time data fetched from the external services 105, a historical database archives old data for trend analysis and historical reporting, and a configuration database stores system configurations and user preferences.

The machine learning modeler 150 builds and applies machine learning models to predict potential issues and optimize system performance. The machine learning modeler 150 uses trains and refines a variety of machine learning models that are used to evaluate metrics to classify or predict heath statuses. Classification models are used to identify potential system instability by analyzing patterns across monitoring data to detect potential issues. Clustering/matching models analyze, process, and merge data from various sources and are used to identify data granularity at different organizational levels (e.g., line of business, product group, product, etc.). Pattern matching models are used for real-time health score calculation and to identify patterns to predict potential system failures. For example, pattern matching detects patterns in swap memory increases that could indicate future system failures. Transformation models convert technical challenges into business terms and transform technical metrics into user impact assessments by using historical data to calculate potential business impact, such as estimating affected user counts during outages based on typical usage patterns.

The analytics engine 155 processes aggregated data from the data aggregator 145 to generate insights, health scores, and predictive analytics. Pattern recognition and historical analysis is used to analyze historical data patterns to identify deviations from normal behavior. Pattern recognition and historical analysis compares current performance metrics against historical baselines, such as typical login volumes or transaction patterns for specific times and days. For example, pattern recognition and historical analysis can detect when trading volumes significantly deviate from expected patterns based on historical data for that particular day and time.

Multi-source data correlation aggregates and correlates data from multiple monitoring tools and sources to identify potential issues. Multi-source data correlation uses classification models to identify potential instability by analyzing patterns across infrastructure, application, and business metrics and fusing data from various monitoring tools to derive health scores for applications and processes.

Real-time monitoring and alerts monitor near real-time performance data with delays (e.g., periodic (e.g., five minutes, etc.), random, on demand, etc.) for data collection and aggregation. Real-time monitoring and alerts can trigger alerts when metrics deviate from expected ranges, such as detecting unusual patterns in swap memory usage that might indicate future system failures. Algorithms are used to determine health status changes (e.g., red/amber/green, etc.) based on incident severity and impact.

Predictive analysis employs predictive models to identify potential failures before they occur. For example, predictive analysis can detect patterns like increasing swap memory usage and predict potential system failures weeks in advance. Transformation models are used to analyze patterns and identify potential issues, converting technical metrics into business impact assessments.

Health score calculation calculates health scores based on multiple factors including incidents, vulnerabilities, and operational issues. Health score calculation uses weighted algorithms to determine a severity of deviations, with major incidents triggering red status, high-priority incidents triggering amber status, and minor issues maintaining green status. The health scores are continuously updated based on real-time data and historical patterns.

Issues are identified by identifying deviations from expected patterns. A variety of deviation may be evaluated depending on the component being evaluated for issue detection. Login and usage pattern deviations include variations from typical login volumes for specific times/days, deviations in expected trading volumes and transaction patterns, abnormal changes in desktop vs mobile login ratios, etc. System performance deviations include unusual patterns in swap memory usage that could indicate potential system failures, changes in application response times from baseline performance, variations in batch processing completion times, etc. Business metric deviations include changes in expected transaction volumes or dollar amounts, variations from typical number of trades submitted during specific time periods, deviations in expected money movement transactions, etc. Infrastructure health deviations include changes in infrastructure stability metrics from normal baselines, variations in application availability metrics, deviations in security and vulnerability metrics from acceptable thresholds, etc. Operational process deviations include changes in incident patterns or volumes, variations from expected change management process metrics, deviations in batch/file ingestion processing patterns, etc.

A variety of issues are identified by the analytics engine 155. System performance issues can be detected based on identification of increasing swap memory patterns that indicate potential system failure (e.g., within two months, etc.), identification of application response time degradation through monitoring tools, early warning of potential infrastructure stability issues through pattern analysis, etc. Business impact issues can be detected based on abnormal drops in trading volumes (e.g., detecting a 5 million trade drop in normal 10 million daily volume, etc.), unexpected decreases in login activity compared to historical patterns, detection of fraud system incorrectly blocking legitimate user access during high-volume periods like tax season, etc. Operational issues can be identified based on identification of batch processing delays or failures, detection of unsuccessful changes or negative impact changes in production systems, early warning of potential vulnerabilities approaching critical deadlines, etc. Integration issues can be detected by identification of service disruptions between integrated systems, identification of data synchronization problems between different monitoring tools, alert on API connectivity issues with monitoring systems, etc. User experience issues can be detected based on identification of increased login failures during specific time periods, identification of money movement transaction processing delays, alert on customer-facing application performance degradation, etc. The identification of the detection triggering event is based on the deviations identified using the various machine learning models such as a pattern matching model.

The UI manager 165 generates and manages UI content request by a user using a variety of components including (1) dashboards that display consolidated views of IT health, performance metrics, and real-time data and (2) an authentication component that manages user access and entitlements, ensuring secure access to the system. Security mechanisms, such as encryption services that ensure that data in transit and at rest is encrypted and compliance monitoring tools that monitor and ensure compliance with IT governance and security policies, may be used to provide additional security for the system 125.

A variety of alerts may be presented in a dashboard, UI, or other presentation medium. Status change notifications alert users when application status changes to amber or red based on incident severity, notify stakeholders when metrics deviate from expected ranges, and signal when health scores indicate potential system issues. Predictive warnings generate alerts before potential system failures, such as warning about increasing swap memory usage weeks before potential failure; notify users of pattern-based predictions for potential infrastructure issues; and alert stakeholders about emerging trends that could impact system stability. Business impact notifications alert when business metrics deviate significantly from historical patterns, notify stakeholders of customer impact during system issues, and signal when transaction volumes or login patterns show abnormal variations. Operational alerts generate notifications for batch processing issues, alert on unsuccessful changes or negative impact changes, and signal when vulnerabilities approach critical deadlines. Real-time monitoring alerts provide near real-time notifications of system health changes at update intervals, alert on integration issues between monitoring tools, and signal when API connectivity issues arise.

A variety of recommended corrective actions may be output to the user or initiated automatically based on rules defined by the user. Automated response actions trigger automated health checks when issues are detected, initiate self-healing events integrated with enterprise tools, and execute automated processes to address identified issues. Operational process actions generate action items for operational teams to address, create announcements and actionable items for stakeholders, and track follow-ups and required actions through an operational process dashboard. Pattern-based remediation identifies patterns to trigger appropriate automation responses, uses classification models to determine necessary corrective steps, and implements feedback loops to improve model training and response accuracy. Infrastructure adjustments recommend infrastructure stability improvements based on monitoring data, suggest changes to prevent recurring issues identified through pattern analysis, and propose system optimization based on performance metrics. Process improvements recommend refinements to operational processes based on monitoring insights, suggests adaptive optimization strategies to enhance stability, and provide data-driven recommendations for improving system performance.

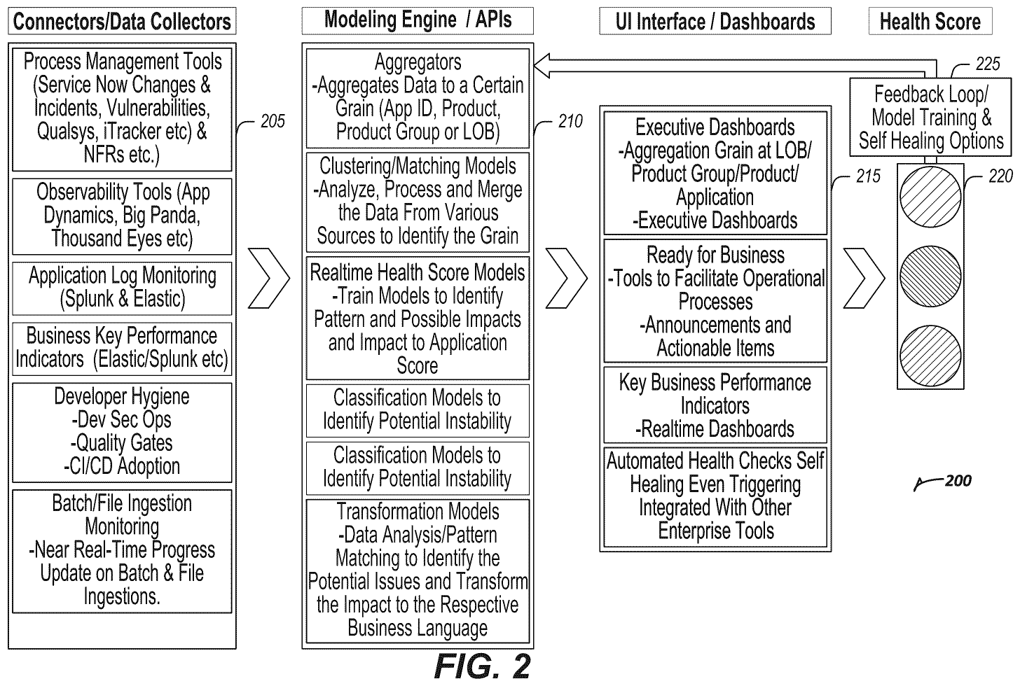

FIG. 2 illustrates a flow diagram of an example of a data flow 200 for scalable modular unified computing infrastructure vulnerability monitoring, according to an embodiment. Connectors and data collectors 205 are used by modeling engines and APIs 210 to obtain data that is processed to generate UI interfaces and dashboards 215 that include status indicators 220. A feedback loop 225 obtains feedback data to refine models used by the modeling engines and APIs 210 and triggers self-healing processes to automatically correct issues detected in the data.

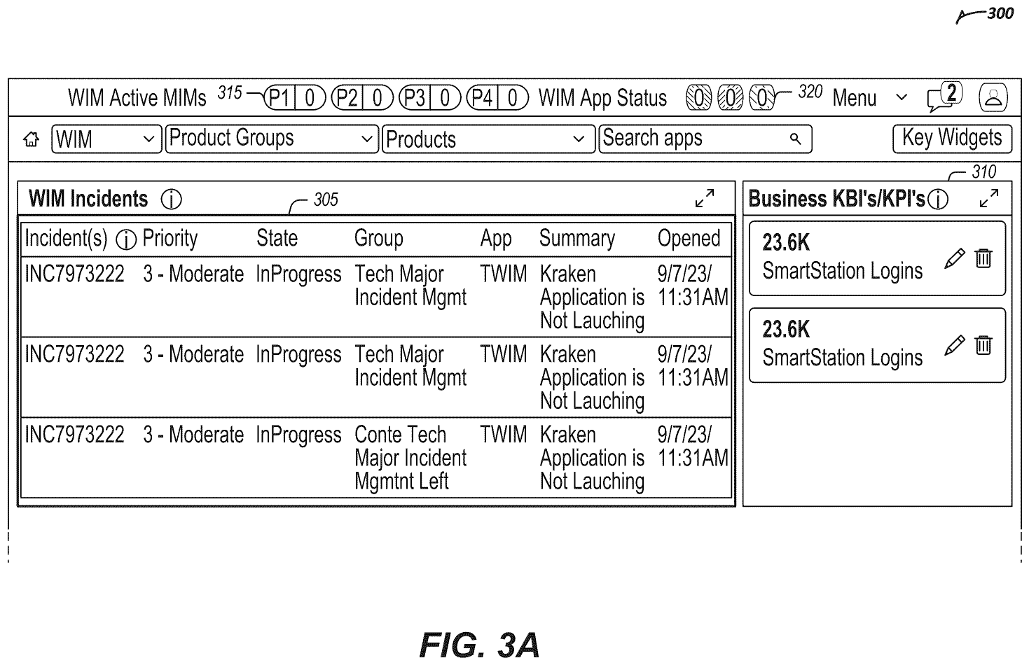

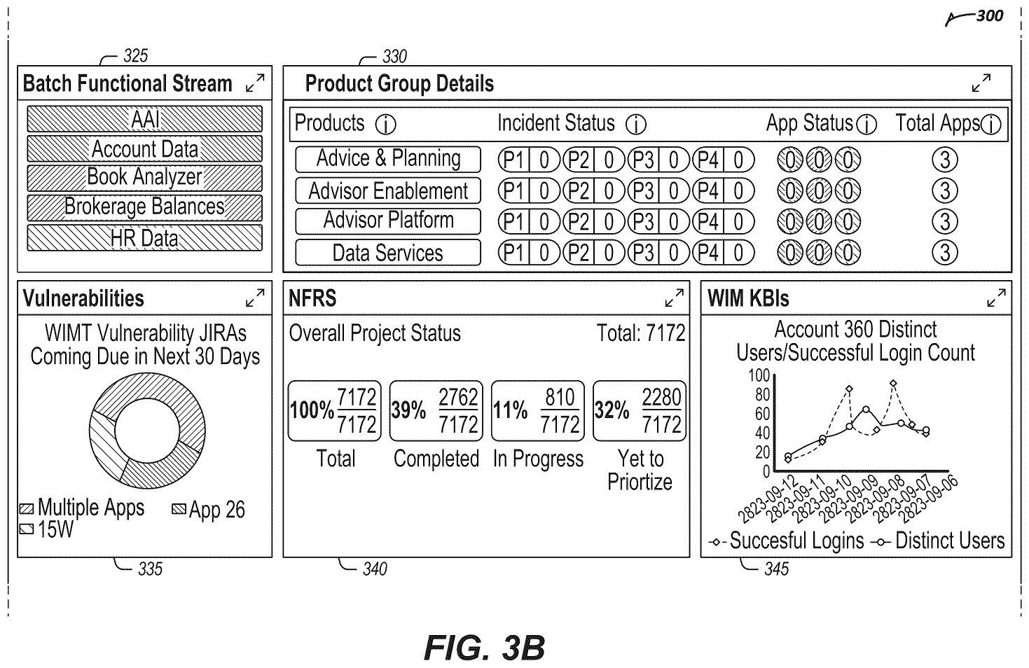

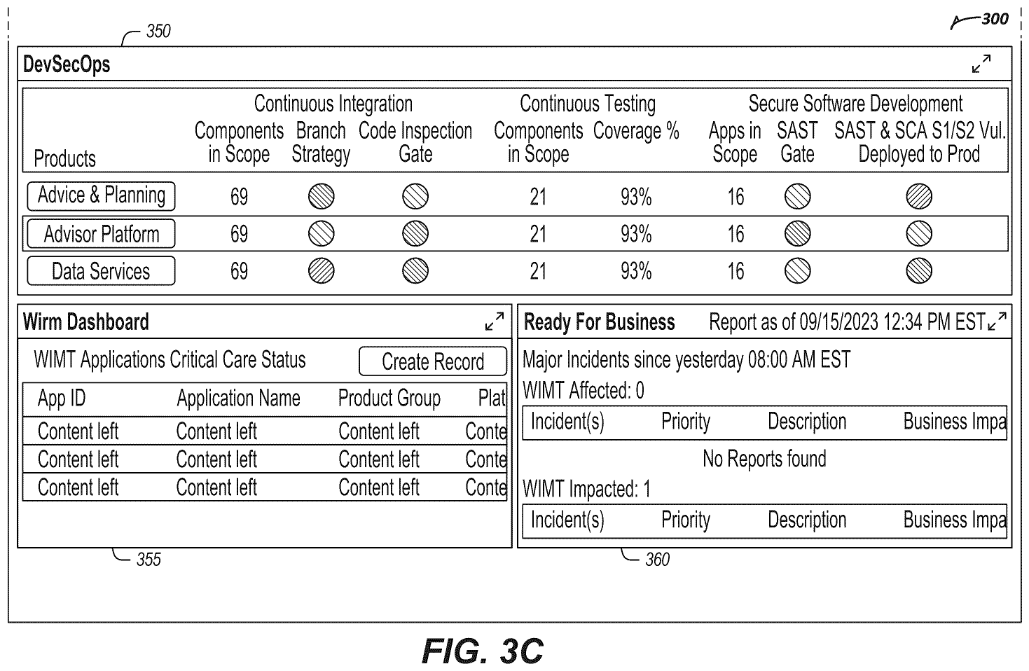

FIGS. 3A, 3B, and 3C illustrate an example of an information technology (IT) dashboard view 300 for scalable modular unified computing infrastructure vulnerability monitoring, according to an embodiment. The IT dashboard view 300 may provide features as described in FIGS. 1 and 2. The IT dashboard view 300 provides a comprehensive and consolidated view of various IT metrics and indicators that are crucial for effective IT infrastructure management.

Health score indicators, such as a count of events by priority 315 and a count of applications by status 315, display the overall health status of different IT components such as applications, servers, and networks. The health score indicators may be color-coded (e.g., green, amber, red, etc.) to reflect the current health status. Clickable icons or links are presented to enable a user to drill down into specific issues or view detailed reports.

Real-time monitoring widgets provide real-time data on critical IT operations. The widget may include graphs and charts showing real-time performance metrics such as central processing unit (CPU) usage, memory consumption, network bandwidth, etc. The widgets are updated dynamically to reflect the current state of the IT infrastructure. An incident management panel widget 305 tracks and manages IT incidents to ensure timely resolution and may include a list of recent incidents with severity ratings, status, and responsible parties. Tools for sorting, filtering, and searching incidents are provided in the IT dashboard view 300 to streamline management processes.

A business impact visualization widget 310 links IT performance with business outcomes to highlight the impact of IT on business operations. Charts and graphs may be provided that correlate IT metrics with business KPIs such as sales, customer satisfaction, operational efficiency, etc. Predictive analytics models are used to evaluate data to suggest predicted potential business impacts based on current IT data. A batch functional stream widget 325 provides visual health indicators for individual batch functions. A product group details widget 330 displays incident and application status for products. A vulnerabilities widget 335 displays graphical representations of bugs and change management items to monitor ongoing changes in the IT environment to prevent and mitigate risks associated with changes. The graphical representations may include a timeline or a calendar view of scheduled changes with status updates on change implementation and any issues arising from changes. A non-functional requirements status widget 340 illustrates completion status of outstanding projects. An application performance metrics widget 345 monitors and displays performance metrics for critical applications. Dashboards for individual applications may show KPIs or KBIs like response time, transaction volume, successful logins, distinct users, error rates, etc. Alerts may be configured to be triggered for performance anomalies or deviations from expected behavior. A security alerts and compliance widget 350 ensures the IT environment adheres to security standards and compliance requirements. Notifications and alerts can be configured to trigger for potential security breaches or vulnerabilities. The compliance tracking widgets show adherence to various regulatory frameworks. Customizable and interactive widget such as widget 355 enable IT staff to customize views and interact with the dashboard to suit specific needs. The IT dashboard view 300 may include drag-and-drop capabilities enabling the user to customize the layout of the dashboard by dragging widgets to new locations within the dashboard. Interactive elements such as sliders and filters may be provided to enable the user to view data for specific time periods or conditions.

A variety of reports may be presented in the IT dashboard view 300 such as a ready for business report 360 that illustrates the impact of IT incidents on business elements. Resource utilization reports may be provided to give a user insight into the utilization of IT resources to optimize allocation and reduce costs. The resource utilization reports provide metrics for resource usage including hardware, software licenses, cloud services, etc. and provide recommendations for resource optimization based on usage patterns.

A variety of logs may be presented in the IT dashboard view 300. For example, a user access and activity log may monitor and audit user activities within the IT systems to ensure security and compliance. The information in the logs may include user activities including logins, data access, and system changes and may include tools for analyzing patterns and detecting unusual or unauthorized activities.

The components of the IT dashboard view 300 provide critical insights and facilitate efficient management of the IT infrastructure to enable an enhance ability to respond to issues proactively and maintain optimal operational stability.

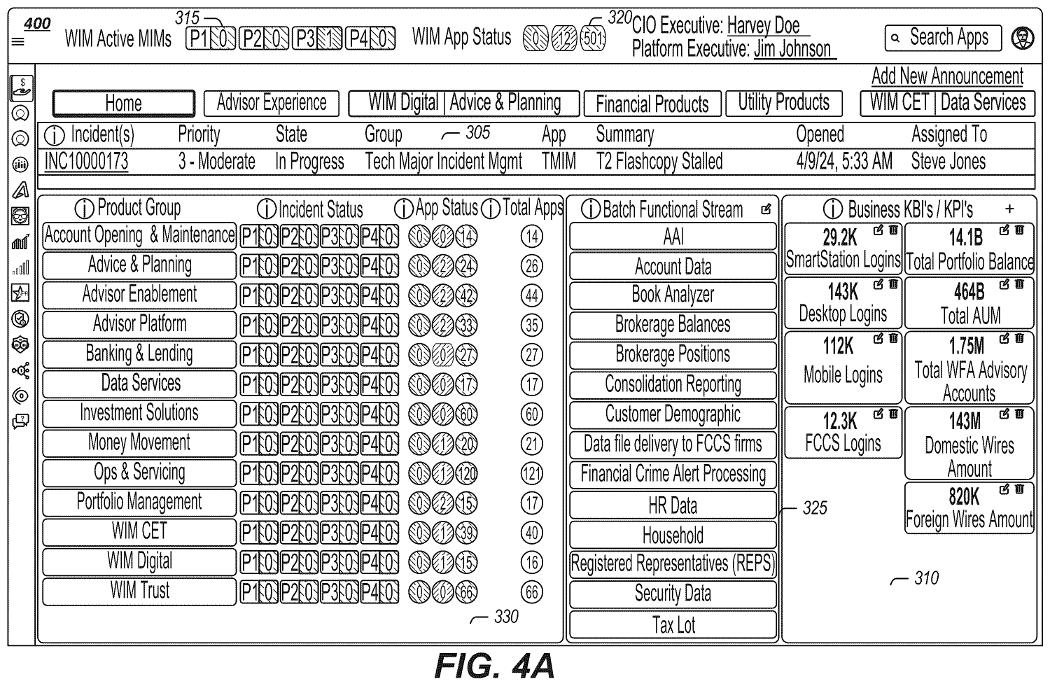

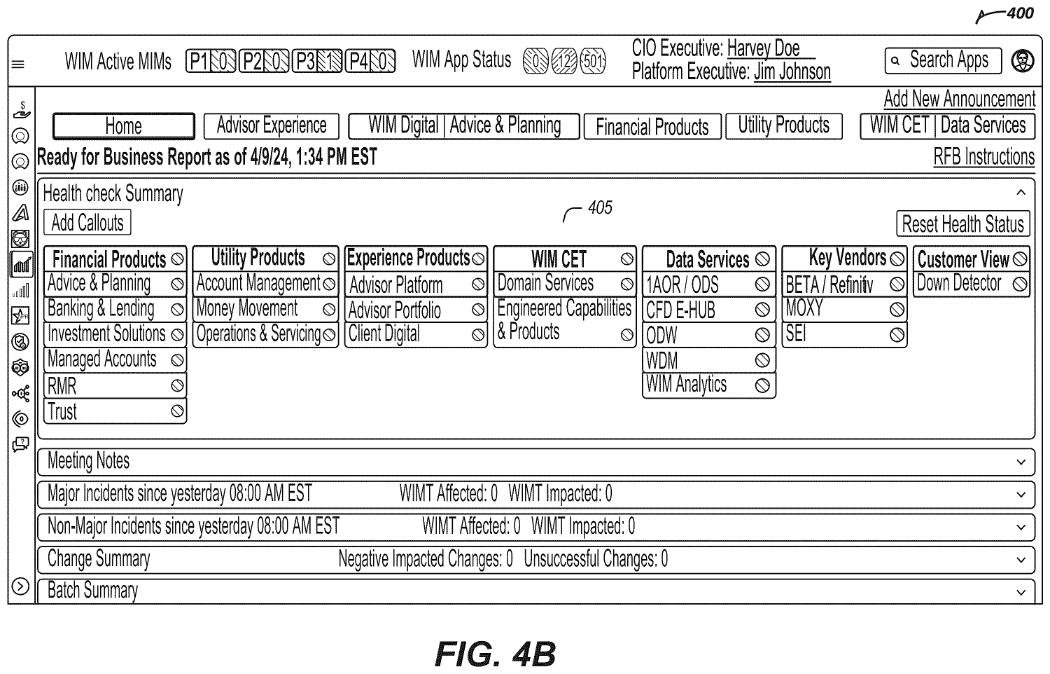

FIGS. 4A and 4B illustrate an example of a business dashboard view 400 for scalable modular unified computing infrastructure vulnerability monitoring, according to an embodiment. The business dashboard view 300 may provide features as described in FIGS. 1 and 2. The business dashboard view 400 provides IT infrastructure health status information to users using relatable business impact metrics rather than using detailed IT metrics as in the IT dashboard view 300. The business dashboard view 400 may include some widgets and reports that are common to the IT dashboard view such as, by way of example and not limitation, health indicators such as the count of events by priority 315 and the count of applications by status 315, the incident management panel widget 305, the business impact visualization widget 310, the batch functional stream widget 325, and the product group details widget 330 as described in FIGS. 3A, 3B, and 3C.

A simplified health check summary widget 405 is provided that illustrates health of IT infrastructure by functional areas that non-technical users may find more useful in identifying critical IT system issues. The business dashboard view 400 may include a variety of business-oriented data that is determined based on analysis of computing system metrics (e.g., as collected from the external services 105 as described in FIG. 1, etc.) transforming the technical data into business relevant data for consumption by non-technical users to enable identification of critical IT infrastructure issues.

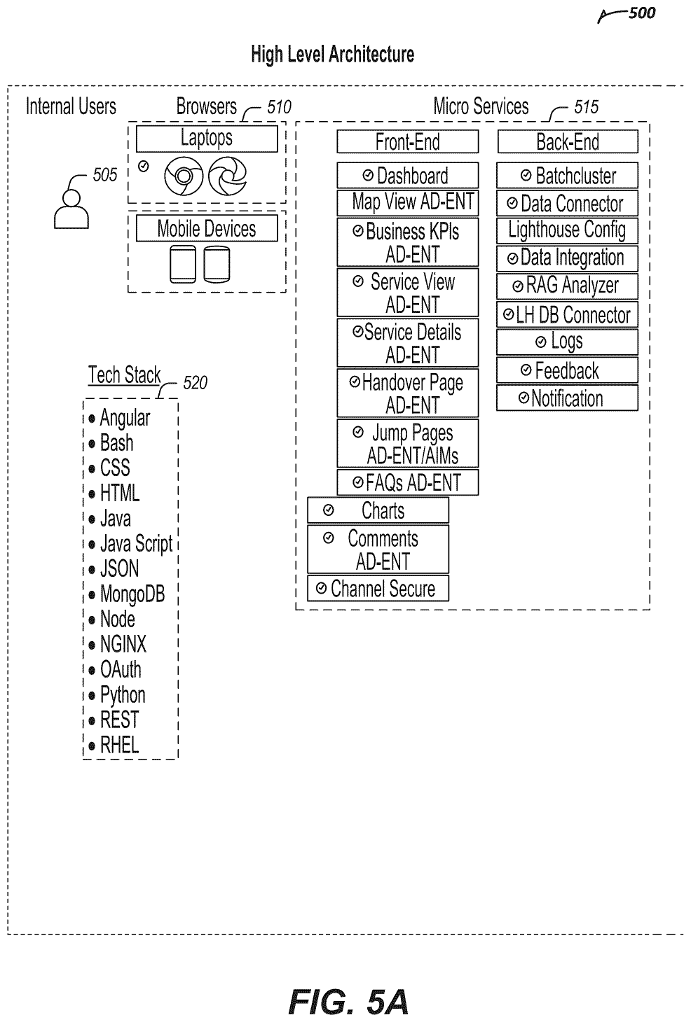

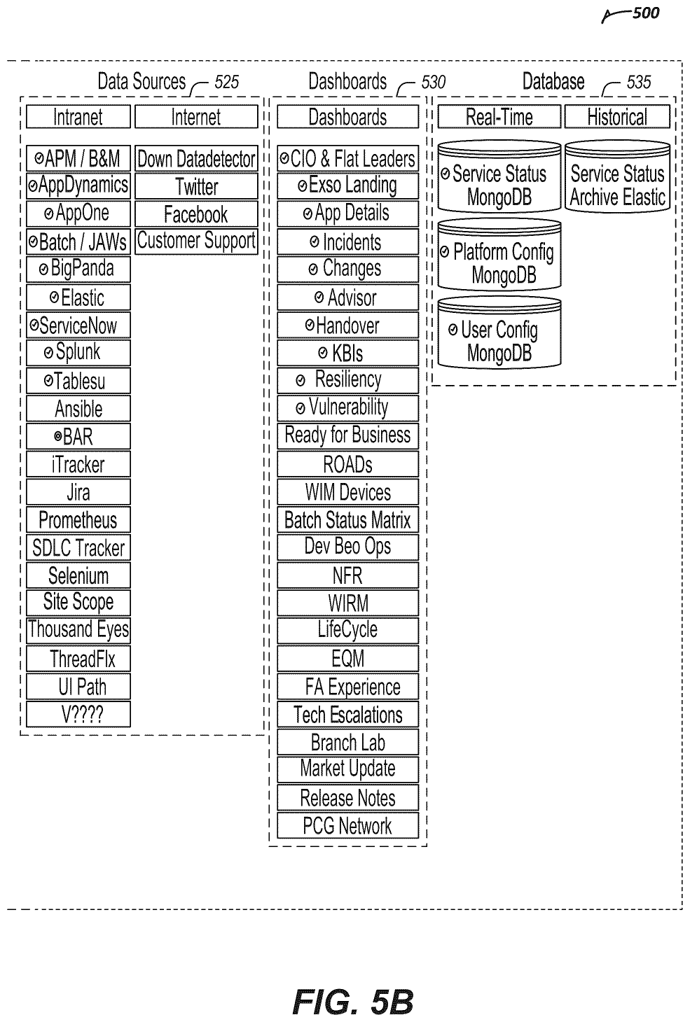

FIGS. 5A and 5B illustrate an example of an architecture 500 for scalable modular unified computing infrastructure vulnerability monitoring, according to an embodiment. The architecture 500 may provide features as described in FIGS. 1, 2, 3A, 3B, 3C, 4A, and 4B. The architecture 500 includes internal users 505, browsers 510 used by the internal users 505, micro services 515 that are accessed by the browsers 510 and employ a variety of technologies included in a technical stack 520. A variety of internal (e.g., intranet, etc.) and external (e.g., internet, etc.) data sources 525 are accessed to collect metrics and other data regarding operation of the technical stack 520 and associated micro services 515. The data collected from the data sources 525 and configuration data is stored in a variety of databases 535. The data from the databases 535 is analyzed to generate a variety of dashboards 530.

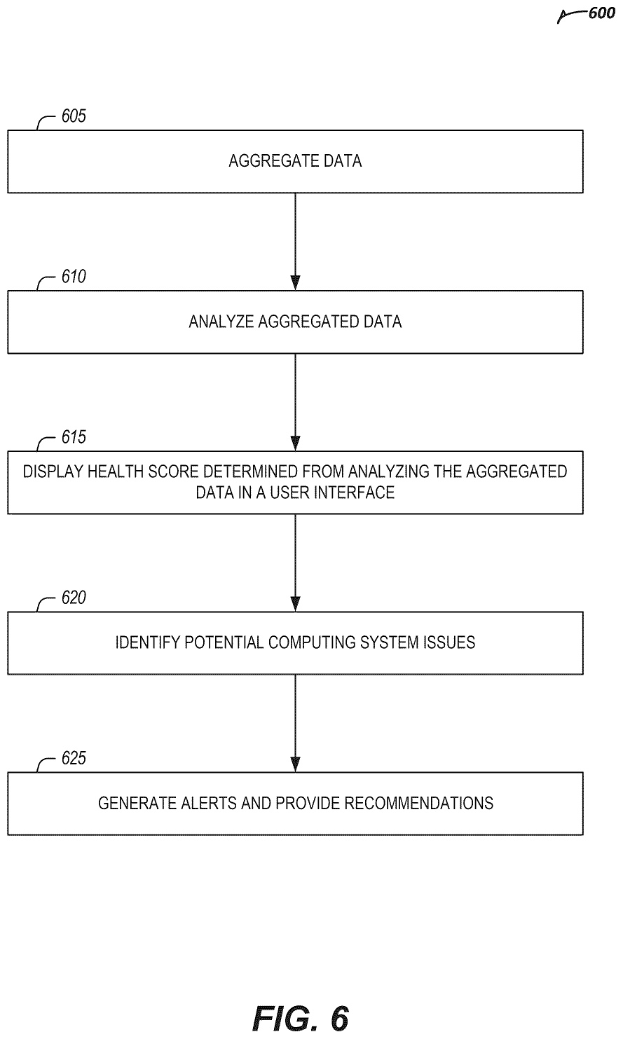

FIG. 6 is a flow diagram of an example of a method 600 for scalable modular unified computing infrastructure vulnerability monitoring, according to an embodiment. The method 600 may provide features as described in FIGS. 1, 2, 3A, 3B, 3C, 4A, 4B, 5A, and 5B.

Data is aggregated (e.g., by the data aggregator 145 as described in FIG. 1, etc.) from multiple computing system monitoring tools (e.g., the external services 105 as described in FIG. 1, etc.) across different computing infrastructure components (e.g., at operation 605). In an example, the computing system monitoring tools may include at least one of: application performance monitoring tools, network monitoring tools, and security monitoring tools.

The aggregated data is analyzed (e.g., by the analytics engine 155 as described in FIG. 1, etc.) to determine a health score for each of the computing infrastructure components based on predefined metrics (e.g., at operation 610). In an example, the predefined metrics used to determine the health scores may include at least one of: system uptime, response time, error rates, and security threat levels. In an example, machine learning algorithms may be employed to predict future computing system issues based on historical data and trends identified from the aggregated data.

The health scores are displayed (e.g., by the UI manager 165 as described in FIG. 1, etc.) in a user interface alongside real-time performance data of the computing infrastructure components (e.g., at operation 615). In an example, change management data may be integrated from a change management system to correlate ongoing changes in the computing system infrastructure with fluctuations in the health scores. In an example, the user interface may provide a consolidated view that includes health scores, real-time performance data, and actionable insights derived from the analyzed data.

Potential computing system issues are identified (e.g., by the analytics engine 155 as described in FIG. 1, etc.) based on deviations in the health scores and performance data from baseline values (e.g., at operation 620).

Alerts corresponding to the identified issues are generated (e.g., by the analytics engine 155 as described in FIG. 1, etc.) and recommended corrective actions to be taken are presented (e.g., by the UI manager 165 as described in FIG. 1, etc.) in the user interface (e.g., at operation 625). In an example the display of health scores and performance data may be customized by a user through the user interface based on user-selected preferences.

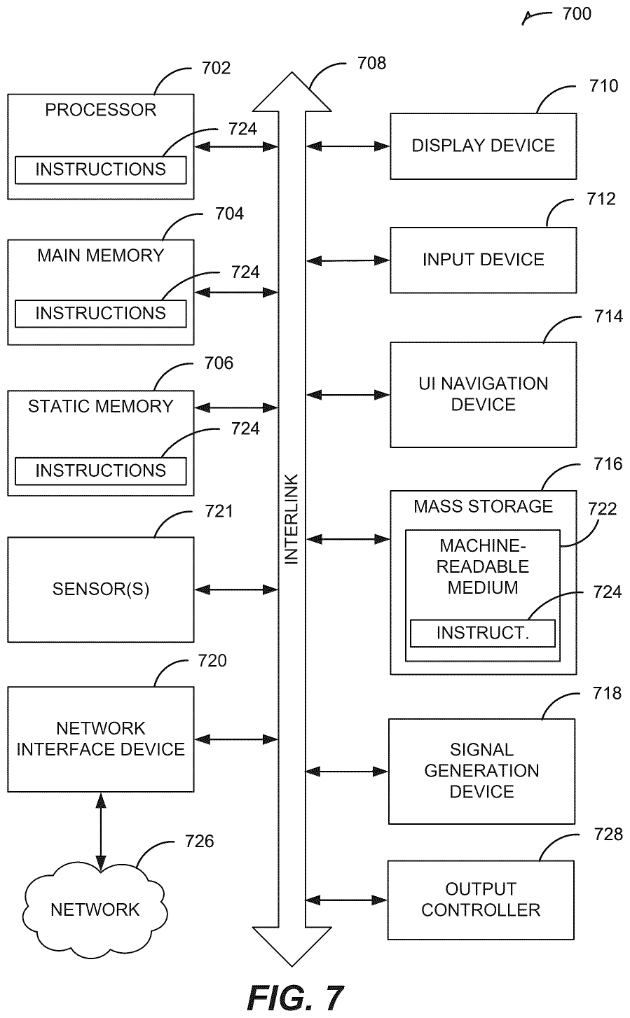

FIG. 7 illustrates a block diagram of an example machine 700 upon which any one or more of the techniques (e.g., methodologies) discussed herein may perform. For example, the user computing device 110 and the server computing device 120 may include components similar to those of the example machine 700. In alternative embodiments, the machine 700 may operate as a standalone device or may be connected (e.g., networked) to other machines. In a networked deployment, the machine 700 may operate in the capacity of a server machine, a client machine, or both in server-client network environments. In an example, the machine 700 may act as a peer machine in peer-to-peer (P2P) (or other distributed) network environment. The machine 700 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or several components, or mechanisms. Circuit sets are a collection of circuits implemented in tangible entities that include hardware (e.g., simple circuits, gates, logic, etc.). Circuit set membership may be flexible over time and underlying hardware variability. Circuit sets include members that may, alone or in combination, perform specified operations when operating. In an example, hardware of the circuit set may be immutably designed to carry out a specific operation (e.g., hardwired). In an example, the hardware of the circuit set may include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuit set in hardware via the variable connections to carry out portions of the specific operation when in operation. Accordingly, the computer readable medium is communicatively coupled to the other components of the circuit set member when the device is operating. In an example, any of the physical components may be used in more than one member of more than one circuit set. For example, under operation, execution units may be used in a first circuit of a first circuit set at one point in time and reused by a second circuit in the first circuit set, or by a third circuit in a second circuit set at a different time.

Machine (e.g., computer system) 700 may include a hardware processor 702 (e.g., a central processing unit (CPU), a graphics processing unit (GPU), a hardware processor core, or any combination thereof), a main memory 704 and a static memory 706, some or all of which may communicate with each other via an interlink (e.g., bus) 708. The machine 700 may further include a display unit 710, an alphanumeric input device 712 (e.g., a keyboard), and a user interface (UI) navigation device 714 (e.g., a mouse). In an example, the display unit 710, input device 712 and UI navigation device 714 may be a touch screen display. The machine 700 may additionally include a storage device (e.g., drive unit) 716, a signal generation device 718 (e.g., a speaker), a network interface device 720, and one or more sensors 721, such as a global positioning system (GPS) sensor, compass, accelerometer, or other sensors. The machine 700 may include an output controller 728, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 716 may include a machine readable medium 722 on which is stored one or more sets of data structures or instructions 724 (e.g., software) embodying or utilized by any one or more of the techniques or functions described herein. The instructions 724 may also reside, completely or at least partially, within the main memory 704, within static memory 706, or within the hardware processor 702 during execution thereof by the machine 700. In an example, one or any combination of the hardware processor 702, the main memory 704, the static memory 706, or the storage device 716 may constitute machine readable media.

While the machine readable medium 722 is illustrated as a single medium, the term “machine readable medium” may include a single medium or multiple media (e.g., a centralized or distributed database, and/or associated caches and servers) configured to store the one or more instructions 724.

The term “machine readable medium” may include any medium that is capable of storing, encoding, or carrying instructions for execution by the machine 700 and that cause the machine 700 to perform any one or more of the techniques of the present disclosure, or that is capable of storing, encoding or carrying data structures used by or associated with such instructions. Non-limiting machine-readable medium examples may include solid-state memories, and optical and magnetic media. In an example, machine readable media may exclude transitory propagating signals (e.g., non-transitory machine-readable storage media). Specific examples of non-transitory machine-readable storage media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 724 may further be transmitted or received over a communications network 726 using a transmission medium via the network interface device 720 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, LoRa®/LoRaWAN® LPWAN standards, etc.), IEEE 802.15.4 family of standards, peer-to-peer (P2P) networks, 3rd Generation Partnership Project (3GPP) standards for 4G and 5G wireless communication including: 3GPP Long-Term evolution (LTE) family of standards, 3GPP LTE Advanced family of standards, 3GPP LTE Advanced Pro family of standards, 3GPP New Radio (NR) family of standards, among others. In an example, the network interface device 720 may include one or more physical jacks (e.g., Ethernet, coaxial, or phone jacks) or one or more antennas to connect to the communications network 726. In an example, the network interface device 720 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that can store, encoding or carrying instructions for execution by the machine 700, and includes digital or analog communications signals or other intangible medium to facilitate communication of such software.

### Additional Notes

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

What is claimed is:

1. A system for modular unified computing infrastructure monitoring comprising:
at least one processor; and
memory comprising instructions that, when executed by the at least one processor, cause the at least one processor to perform operations to:
aggregate data from multiple computing system monitoring tools across different computing infrastructure components;
analyze the aggregated data to determine health scores, the health scores comprising a health score for each of the computing infrastructure components based on predefined metrics;
display, on a user interface, the health scores alongside real-time performance data of the computing infrastructure components;
identify a potential computing system issue based on deviations of the health scores and performance data from baseline values corresponding for a computing system associated with the computing infrastructure components; and
generate an alert corresponding to the potential computing system issue and present recommended corrective actions to be taken in the user interface.

2. The system of claim 1, wherein the computing system monitoring tools include at least one of: application performance monitoring tools, network monitoring tools, and security monitoring tools.

3. The system of claim 1, the memory further comprising instructions that, when executed by at least one processor, cause the at least one processor to perform operations to integrate change management data from a change management system to correlate ongoing changes in the computing system infrastructure with fluctuations in the health scores.

4. The system of claim 1, wherein the predefined metrics used to determine the health scores include at least one of: system uptime, response time, error rates, and security threat levels.

5. The system of claim 1, the memory further comprising instructions that, when executed by at least one processor, cause the at least one processor to perform operations to customize, by a user through the user interface, the display of health scores and performance data based on user-selected preferences.

6. The system of claim 1, wherein the user interface provides a consolidated view that includes health scores, real-time performance data, and actionable insights derived from the analyzed data.

7. The system of claim 1, the memory further comprising instructions that, when executed by at least one processor, cause the at least one processor to perform operations to employ machine learning algorithms to predict future computing system issues based on historical data and trends identified from the aggregated data.

8. At least one non-transitory machine-readable medium for modular unified computing infrastructure monitoring comprising instructions that, when executed by at least one processor, cause the at least one processor to perform operations to:
aggregate data from multiple computing system monitoring tools across different computing infrastructure components;
analyze the aggregated data to determine health scores, the health scores comprising a health score for each of the computing infrastructure components based on predefined metrics;
display, on a user interface, the health scores alongside real-time performance data of the computing infrastructure components;
identify a potential computing system issue based on deviations of the health scores and performance data from baseline values corresponding for a computing system associated with the computing infrastructure components; and
generate an alert corresponding to the potential computing system issue and present recommended corrective actions to be taken in the user interface.

9. The at least one non-transitory machine-readable medium of claim 8, wherein the computing system monitoring tools include at least one of: application performance monitoring tools, network monitoring tools, and security monitoring tools.

10. The at least one non-transitory machine-readable medium of claim 8, further comprising instructions that, when executed by at least one processor, cause the at least one processor to perform operations to integrate change management data from a change management system to correlate ongoing changes in the computing system infrastructure with fluctuations in the health scores.

11. The at least one non-transitory machine-readable medium of claim 8, wherein the predefined metrics used to determine the health scores include at least one of: system uptime, response time, error rates, and security threat levels.

12. The at least one non-transitory machine-readable medium of claim 8, further comprising instructions that, when executed by at least one processor, cause the at least one processor to perform operations to customize, by a user through the user interface, the display of health scores and performance data based on user-selected preferences.

13. The at least one non-transitory machine-readable medium of claim 8, wherein the user interface provides a consolidated view that includes health scores, real-time performance data, and actionable insights derived from the analyzed data.

14. The at least one non-transitory machine-readable medium of claim 8, further comprising instructions that, when executed by at least one processor, cause the at least one processor to perform operations to employ machine learning algorithms to predict future computing system issues based on historical data and trends identified from the aggregated data.

15. A method for modular unified computing infrastructure monitoring comprising:
aggregating, by a processor, data from multiple computing system monitoring tools across different computing infrastructure components;
analyzing, by the processor, the aggregated data to determine health scores, the health scores comprising a health score for each of the computing infrastructure components based on predefined metrics;
displaying, on a user interface, the health scores alongside real-time performance data of the computing infrastructure components;
identifying, by the processor, a potential computing system issue based on deviations of the health scores and performance data from baseline values corresponding for a computing system associated with the computing infrastructure components; and
generating, by the processor, an alert corresponding to the potential computing system issue and present recommended corrective actions to be taken in the user interface.

16. The method of claim 15, wherein the computing system monitoring tools include at least one of: application performance monitoring tools, network monitoring tools, and security monitoring tools.

17. The method of claim 15, further comprising integrating, by the processor, change management data from a change management system to correlate ongoing changes in the computing system infrastructure with fluctuations in the health scores.

18. The method of claim 15, wherein the predefined metrics for determining the health scores include at least one of: system uptime, response time, error rates, and security threat levels.

19. The method of claim 15, further comprising customizing, by a user through the user interface, the display of health scores and performance data based on user-selected preferences.

20. The method of claim 15, wherein the user interface provides a consolidated view that includes health scores, real-time performance data, and actionable insights derived from the analyzed data.

21. The method of claim 15, further comprising employing, by the processor, machine learning algorithms to predict future computing system issues based on historical data and trends identified from the aggregated data.
